(19) United States
(12) Patent Application Publication
(10) Pub. No.: US 2024/0217848 A1
(43) Pub. Date: Jul. 4, 2024

(54) A method for producing cationic saccharides

(71) Applicant: Kemira Oyj, Helsinki (FI)

(72) Inventors: Jaakko HILTUNEN, Helsinki (FI); Jonni AHLGREN, Espoo (FI); Carmen BOERIU, Wageningen (NL); Jan STOUTJESDIJK, Wageningen (NL); Ted SLAGHEK, Wageningen (NL); Johan TIMMERMANS, Wageningen (NL); Guus FRISSEN, Wageningen (NL)

(21) Appl. No.: 18/569,616

(22) PCT Filed: Jun. 13, 2022
(86) PCT No.: PCT/FI2022/050410

§ 371 Date: Dec. 13, 2023

(30) Foreign Application Priority Data
Jun. 15, 2021 (FI) 20215697

(51) Int. Cl. C02F 1/52; C08B 31/12; C08B 37/16; D21H 17/24; D21H 17/29; D21H 21/10

(52) U.S. Cl. CPC C02F 1/5263; C08B 31/125; C08B 37/0012; D21H 17/24; D21H 17/29; D21H 21/10

(57) ABSTRACT

The present invention relates to a method for producing cationic saccharide comprising providing a mixture comprising betaine aldehyde and a saccharide; allowing the betaine aldehyde to react with the saccharide; and obtaining cationic saccharide. The present invention additionally relates to use of the cationic saccharide in water treatment and in paper treatment.

### TECHNICAL FIELD

The present disclosure generally relates to a method for producing cationic saccharides. The disclosure relates particularly, though not exclusively, to a method for producing cationic saccharides by reacting saccharide with betaine aldehyde.

### BACKGROUND

This section illustrates useful background information without admission of any technique described herein representative of the state of the art.

Flocculation is a water treatment process where solids form larger clusters, or flocs, to be removed from water. Flocculants are substances that promote agglomeration of fine particles present in a solution, creating a floc, which then floats to the surface (flotation) or settles to the bottom (sedimentation).

Flocculants can be organic or inorganic, and come in various charges, charge densities, molecular weights, and forms.

Organic polymeric flocculants are widely used, due to their ability to promote flocculation with a relatively low dosage. Although, their lack of biodegradability and the associated dispersion of potentially harmful monomers into water supplies is causing the focus to shift to biopolymers, which are more environmentally friendly. The problem with these is they have a shorter shelf-life, and require a higher dosage than organic polymeric flocculants. To combat this, combined solutions are being developed, where synthetic polymers are grafted onto natural polymers, to create tailored flocculants for water treatment that deliver the optimum benefits of both.

In waste water treatment, metal ion scavangers are used for removing metal ions from the waste water. The scavangers react with various heavy metal ions, such as Fe^{3+/2+}, Hg²⁺, Cd²⁺, Cu²⁺, Pb²⁺, Mn²⁺, Ni²⁺, Zn²⁺, and generate insoluble chelate salts that are removed.

There is still a need for new methods for producing more environtally friendly polymers for water treatment purposes

### SUMMARY

In a first aspect the present invention provides a method for producing cationic saccharide, comprising providing a mixture comprising betaine aldehyde and a saccharide; allowing the betaine aldehyde to react with the saccharide; and obtaining cationic saccharide.

In a second aspect the present invention provides a cationic saccharide comprising a saccharide derivatized with betaine aldehyde.

In a third aspect the present invention provides an use of betaine aldehyde for producing cationic saccharides.

In a fourth aspect, the present invention provides an use of the cationic saccharide produced with the method of the present invention or the cationic saccharide of the present invention as a water treatment agent, preferably as a flocculant in water treatment, in paper treatment, as a retention agent, in anionic trash fixing or as a fixative.

It was surprisingly found that cationic saccharides can be produced by reacting saccharides with betaine aldehyde. The method of the present invention provides environmentally friendly method for producing cationic saccharides of biological origin which cationic saccharides are biodegradable. The cationic saccharides are produced via a route avoiding epoxide chemistry.

It was additionally surprisingly found that water and/or a deep eutectic solvent (DES) system can be used as liquid medium in the reaction.

It was also surprisingly found that the cationic saccharides can be used in several applications, such as as a water treatment agent for example as a flocculant, in paper treatment, as a retention agent, in anionic trash fixing or as a fixative.

The appended claims define the scope of protection.

### DETAILED DESCRIPTION

In a first aspect the present invention provides a method for producing cationic saccharides. More particularly the present invention provides provides a method for producing cationic saccharide, comprising providing a mixture comprising betaine aldehyde and a saccharide; allowing the betaine aldehyde to react with the saccharide; and obtaining a cationic saccharide.

Betaine aldehyde reacts with primary hydroxyl group of a saccharide, thus forming a cationic saccharide i.e. a saccharide derivatized with betaine aldehyde.

In one embodiment one primary hydroxyl group of a saccharide react with betaine aldehyde, thus providing a cationic saccharide.

In one embodiment two or more of primary hydroxyl groups of a saccharide react with two or more betaine aldehyde molecules, thus providing a cationic saccharide.

In one embodiment the reaction of betaine aldehyde with a saccharide takes place in a liquid medium or a mixture of liquid mediums.

In one embodiment the betaine aldehyde is obtained from choline chloride by oxidation.

In one embodiment the mixture comprising the betaine aldehyde and a saccharide is obtained by oxidizing choline chloride for producing a solution comprising betaine aldehyde; and adding a saccharide to the solution comprising betaine aldehyde for producing a mixture comprising betaine aldehyde and saccharide.

In one embodiment a catalyst is present in the oxidation of choline chloride.

In one embodiment a catalyst is present in the reaction of betaine aldehyde with a saccharide.

In one embodiment temperature in the reaction of betaine aldehyde with a saccharide is from 15° C. to 100° C., preferably from 20° C. to 90° C., more preferably from 20° C. to 80° C.

In one embodiment pH of the mixture comprising betaine aldehyde and a saccharide is 2-12, preferably 4-12, more preferably 6-12, even more preferably 9-11.

In one embodiment pH in the reaction of betaine aldehyde with a saccharide is 3-11, preferably 3-9, more preferably 4-8.

In one embodiment pH in the reaction of betaine aldehyde with a saccharide is maintained basic, preferably at 8-12, more preferably at 9-11. The pH can be maintained at desired pH by adjusting the pH by adding suitable base or suitable acid to reach the desired pH.

In one embodiment the liquid medium is water, deep eutectic solvent (DES) system or a mixture thereof.

Deep eutectic solvents (DES), i.e. DES systems are biodegradable and versatile chemicals. DES are fluids generally composed of two or three compounds that are capable of self-association through hydrogen bond interactions, to form eutectic mixtures with a melting point lower than that of each individual component. For example, the freezing point of a eutectic of choline chloride (ChCI) and urea mixed in a 1:2 molar ratio is 12° C., which is considerably lower than that of ChCI (302° C.) and urea (133° C.).

In one embodiment the eutectic solvent (DES) system comprises betaine based DES system, choline chloride based DES system or a mixture thereof.

In one embodiment the deep eutectic solvent (DES) system comprises betaine DES with 1,3-dimethylurea, betaine DES with 1,3-dimethylurea and water, betaine DES with N-methylurea, betaine DES with N-methylurea and water, betaine DES with glycerol, choline chloride DES with 1,3-dimethylurea, choline chloride DES with 1,3-dimethylurea and water, choline chloride DES with N-methylurea, choline chloride DES with N-methylurea and water, choline chloride DES with isosorbide, betaine hydrochloride with 1-methylurea, chlorocholine chloride with 1-methylurea or a mixture thereof.

In one embodiment the deep eutectic solvent (DES) system comprises betaine DES with 1,3-dimethylurea in molar ratio of 1:2, betaine DES with 1,3-dimethylurea and water in molar ratio of 1:2:1, betaine DES with N-methylurea in molar ratio of 1:2, betaine DES with N-methylurea and water in molar ratio of 1:2:1, betaine DES with glycerol in molar ratio of 1:2, choline chloride DES with 1,3-dimethylurea in molar ratio of 1:2, choline chloride DES with 1,3-dimethylurea and water in molar ratio of 1:2:1, choline chloride DES with N-methylurea in molar ratio of 1:2, choline chloride DES with N-methylurea and water in molar ratio of 1:2:1, choline chloride DES with isosorbide in molar ratio of 1:2, betaine hydrochloride with 1-methylurea in molar ratio of 1:2, chlorocholine chloride with 1-methylurea in molar ratio of 1:2 or a mixture thereof.

In one embodiment the saccharide comprises monosaccharides, disaccharides, oligosaccharides, polysaccharides or a mixture thereof.

In one embodiment the monosaccharide comprises glucose, fructose, galactose, mannose or a mixture thereof.

In one embodiment the disaccharide comprises sucrose, lactose, maltose or a mixture thereof.

In one embodiment the oligosaccharide comprises glycan, raffinose, maltodextrin, cellodextrin, hemicelluloses or a mixture thereof.

In one embodiment the hemicelluloses comprises xylans, glucomannan, galactans, glucans, xyloglucans, pectic substances, arabinan, arabinogalactans, glucuron mannans or a mixture thereof.

In one embodiment the polysaccharide comprises starch, glycogen, galactogen, cellulose, chitosan, chitin, guar gum, pectin, dextran, α-glucan, cyclodextrin such as β-cyclodextrin or a mixture thereof.

In one embodiment the cellulose comprises wood based cellulose, plant based cellulose e.g. cotton or a mixture thereof.

In one embodiment the betaine aldehyde is obtained from choline chloride by enzymatic oxidation.

In one embodiment the mixture comprising the betaine aldehyde and a saccharide is obtained oxidizing choline chloride with choline oxidase for producing a solution comprising betaine aldehyde; and adding a saccharide to the solution comprising betaine aldehyde for producing a mixture comprising betaine aldehyde and saccharide.

In one embodiment a catalase is present in the enzymatic oxidation of choline chloride.

One or more of the above embodiments can be combined.

In a second aspect the present invention provides a cationic saccharide. More particularly the present invention provides a cationic saccharide comprising a saccharide derivatized with betaine aldehyde.

In one embodiment the saccharide comprises monosaccharides, disaccharides, oligosaccharides, polysaccharides or a mixture thereof.

In one embodiment the monosaccharide comprises glucose, fructose, galactose, mannose or a mixture thereof.

In one embodiment the disaccharide comprises sucrose, lactose, maltose or a mixture thereof.

In one embodiment the oligosaccharide comprises glycan, raffinose, maltodextrin, cellodextrin, hemicelluloses or a mixture thereof.

In one embodiment the hemicelluloses comprises xylans, glucomannan, galactans, glucans, xyloglucans, pectic substances, arabinan, arabinogalactans, glucuronomannans or a mixture thereof.

In one embodiment the polysaccharide comprises starch, glycogen, galactogen, cellulose, chitosan, chitin, guar gum, pectin, dextran, α-glucan, cyclodextrin such as β-cyclodextrin, or a mixture thereof.

In one embodiment the cellulose comprises wood based cellulose, plant based cellulose e.g. cotton or a mixture thereof.

In one embodiment the cationic saccharide is starch derivatized with betaine aldehyde or cyclodextrin, such as β-cyclodextrin, derivatized with betaine aldehyde.

In one embodiment the cationic saccharide is produced with the method of the present invention.

In a third aspect the present invention provides an use of betaine aldehyde for producing cationic saccharides.

In a fourth aspect the present invention provides an use of the cationic saccharide produced with the method of the present invention or the cationic saccharide of the present invention as a water treatment agent, preferably as a flocculant in water treatment, in paper treatment, as a retention agent, in anionic trash fixing or as a fixative.

### EXAMPLES

### Example 1. Synthesis of betaine DES with 1,3-dimethylurea according to the present invention

5.75 g (0.05 moles) of betaine (GB) were mixed with 8.81 g (0.1 moles) of 1,3-dimethylurea (DMU) in 100-mL round-bottomed flask with magnetic stirring and heated 348.15 K (75° C.) for several hours, at 200 rpm. Magnetic mixing appeared inefficient and after 1 h, the synthesis was continued in a Rotavapor at 75° C. under constant rotation. No fluid phase was obtained after 4 h at 75° C., indicating that the Tm of this mixture is higher. The product is referred further as (GB-1).

### Example 2. Synthesis of Betaine DES with 1,3-Dimethylurea and Water According to the Present Invention

5.75 g (0.05 moles) of betaine (GB) were combined with 8.81 g (0.1 moles) of 1,3-dimethylurea (DMU) and 0.9 g (0.05 moles) of water in 50-mL round-bottomed flask and heated 348.15 K (75° C.) a Rotavapor under constant rotation. The mixture partially melted after 1.5 h at 75° C. and solidified immediately when taken out of the water bath. At room temperature it was a solid homogeneous material. The product is referred further as GB-2.

### Example 3. Synthesis of Betaine DES with N-Methylurea According to the Present Invention

5.75 g (0.05 moles) of betaine (GB) were combined with 7.45 g (0.1 moles) of N-methylurea (MU) in 100-mL round-bottomed flask and heated at 348.15 K (75° C.) in a Rotavapor under constant rotation. A flowing suspension was obtained after 2 h. GB-3 mixture only partially melted and hardened slowly when cooling in air and was a solid at room temperature. The product is referred further as GB-3.

### Example 4. Synthesis of Betaine DES with N-Methylurea and Water According to the Present Invention

5.75 g (0.05 moles) of betaine (GB) were admixed with 7.45 g (0.1 moles) of N-methylurea (MU) and 0.9 g (0.05 moles) of water in 50-mL round-bottomed flask and heated at 348.15 K (75° C.)a Rotavapor (rotating evaporation system) under constant rotation. A clear, transparent fluid was obtained after 15 min at 75° C. The GB-MU-water DES obtained was a liquid for at least few hours at room temperature but solidified overnight. The product is referred further as BET-4.

### Example 5. Synthesis of Betaine DES with Glycerol According to the Present Invention

5.75 g (0.05 moles) of betaine (GB) were mixed with 9.21 g (0.1 moles) of glycerol (GLY) in a 100-mL round-bottomed flask and heated at 348.15 K (75° C.)a Rotavapor under constant rotation. A clear, transparent fluid was obtained after 20 min at 75° C. The GB-GLY DES obtained was stable as a colourless viscous fluid at RT. The product is referred further as GB-5.

Table 1 shows characteristics of betaine DES systems obtained from Examples 1-5 (HBD in Table 1 stands for hydrogen donor).

TABLE 1
Characteristics of betaine DES systems.

| | | GB:HBD | GB:HBD:H2O | |
|---|---|---|---|---|
| Sample | HBD | (molar ratio) | (molar ratio) | Physical state |
| Ex1 (GB-1) | DMU | 1:2 | | Solid at 75° C. |
| Ex2 (GB-2) | DMU | | 1:2:1 | Suspension at |
| | | | | 75° C., solid at |
| | | | | T < 75° C. |
| Ex3 (GB-3) | MU | 1:2 | | Suspension at |
| | | | | 75° C., solid at |
| | | | | T < 75° C. |
| Ex4 (GB-4) | MU | | 1:2:1 | Liquid at 75° C., |
| | | | | Liquid at RT |
| | | | | (short time) |
| Ex5 (GB-5) | GLY | 1:2 | | Liquid at 75° C., |
| | | | | Liquid at RT |

### Example 6. Synthesis of Choline Chloride DES with 1,3-Dimethylurea According to the Present Invention

6.98 g (0.05 moles) of choline chloride (ChCI) were mixed with 8.81 g (0.1 moles) of 1,3-dimethylurea (DMU) in 100-mL round-bottomed flask and heated 348.15 K (75° C.) in a Rotavapor at 75° C. under constant rotation. A clear, transparent solution was obtained after 3 h at 75° C. The ChCI-DMU DES is solid at room temperature. The product is referred further as ChCI-1.

### Example 7. Synthesis of Choline Chloride DES with 1,3-Dimethylurea and Water According to the Present Invention

6.98 g (0.05 moles) of choline chloride (ChCI) were combined with 8.81 g (0.1 moles) of 1,3-dimethylurea (DMU) and 0.9 g (0.05 moles) of water in 50-mL round-bottomed flask and heated 348.15 K (75° C.) a Rotavapor under constant rotation. A clear solution was obtained after 1 h at 75° C., which hardened upon cooling. Upon heating, ChCI-2 melts and becomes a liquid at a temperature around 50° C. The product is referred further as ChCI-2.

### Example 8. Synthesis of Choline Chloride DES with N-Methylurea According to the Present Invention

6.98 g (0.05 moles) of choline chloride (ChCI) were mixed with 7.45 g (0.1 moles) of N-methylurea (MU) in 100-mL round-bottomed flask and heated 348.15 K (75° C.) in a Rotavapor under constant rotation. A clear solution was obtained after 10 min at 75° C.(FIG. 3A), which hardens upon cooling in air. The product is referred further as ChCI-3.

### Example 9. Synthesis of Choline Chloride DES with N-Methylurea and Water According to the Present Invention

6.98 g (0.05 moles) of choline chloride (ChCI) were mixed with 7.45 g (0.1 moles) of N-methylurea (DMU) and 0.9 g (0.05 moles) of water in 50-mL round-bottomed flask and heated 348.15 K (75° C.)a Rotavapor (rotating evaporation system) under constant rotation. A clear, transparent fluid was obtained after 10 min at 75° C. (FIG. 3B), which remains in a fluid state for at least 72 hours at RT. The product is referred further as ChCI-4.

### Example 10. Synthesis of Choline Chloride DES with Isosorbide According to the Present Invention

6.98 g (0.05 moles) choline chloride (ChCI) were mixed with 14.6 g (0.1 moles) of isosorbide (IS) in a 100-mL round-bottomed flask and heated 348.15 K (75° C.)a Rotavapor under constant rotation. A clear, transparent fluid was obtained after 10 min at 75° C. The ChCI-IS DES obtained was stable as a colourless viscous fluid at RT. The product is referred further as ChCI-5.

Table 2 shows characteristics of choline chloride DES systems obtained from Examples 6-10 (HBD in Table 2 stands for hydrogen donor).

TABLE 2
Characteristics of choline chloride DES systems.

| | | GB:HBD | GB:HBD:H2O | |
|---|---|---|---|---|
| Sample | HBD | (molar ratio) | (molar ratio) | Physical state |
| Ex1 (ChCl-1) | DMU | 1:2 | | Liquid at 75° C., |
| | | | | solid at RT |
| Ex2 (ChCl-2) | DMU | | 1:2:1 | Liquid at 75° C., |
| | | | | solid at RT |
| Ex3 (ChCl-3) | MU | 1:2 | | Liquid at 75° C., |
| | | | | solid at RT |
| Ex4 (ChCl-4) | MU | | 1:2:1 | Liquid at 75° C., |
| | | | | solid at RT, |
| | | | | solid melts |
| | | | | upon heating at |
| | | | | 50° C. |
| Ex5 (ChCl-5) | IS | 1:2 | | Liquid at RT |

Additionally two other DES systems, based on (i) betaine hydrochloride with 1-methylurea (GBCI:MU, 1:2) and (ii) chlorocholine chloride with 1-methylurea (CCC:MU, 1:2), were produced. The two DES systems were synthesised similarly as in Example 8.

### Example 11. Production of Betaine Aldehyde from Choline Chloride by Enzymatic Oxidation and Derivatizing Starch with Betaine Aldehyde According to the Present Invention

Production of Betaine Aldehyde from Choline Chloride

In a three neck round bottom flask (250 ml) equipped with a condenser, 100 ml of a 0.5 M choline chloride in 20 mM natrium-phosphate buffer pH 7.5 was added. The solution was heated at 30° C. with mixing and constant air flow. The reaction was initiated by addition of catalase (5 ml, 40 mg/mL) and choline oxidase (5 ml, 16 mg/mL). Reaction was maintained at 30° C., with mixing and aeration for 5 hours. Due to high enzyme amount and aeration, foaming occurred, and the mixture was set in a bigger reactor (500 ml) to prevent excessive foaming. Reaction was followed by NMR in time, and a slowing down of the conversion was observed, that was mainly caused by a pH drop to pH 5, due most probably to betaine formation. The pH was adjusted to the initial value (pH 7.5) any time it was needed, and an additional amount of enzyme (26 mg choline chloride and 66 mg catalase). Reaction was stopped at 40.5% betaine aldehyde content. Reaction volume (at the end) was 140 ml at pH=5.4. The volume of the reaction mixture was reduced to 20 ml using Rotavapor at 70-75° C., with vacuo. The mixture contains about 40.5 mol % betaine aldehyde, 49.9 mol % choline and 9.6 mol % betaine.

Derivatizing Starch with Betaine Aldehyde

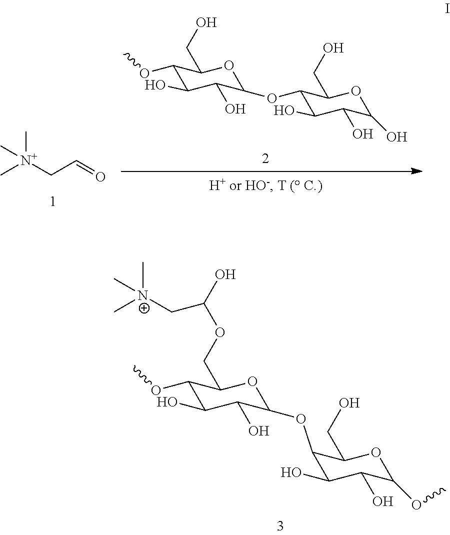

5 grams of native potato starch (2) was added to 20 ml of aqueous solution containing 20 mmoles of betaine aldehyde (1) adjusted to pH 10. The mixture was stirred overnight in a beaker, pH was checked again (9.4) and adjusted to 10.1, and then it was transferred to a 50 ml round bottom flask and attached to a Rotavapor. Water was gradually removed (40° C.; 20-30 mbar (gradually lowered) in approx.. 1-1.5 hours). The solid was dried further in the oven, at 40° C., with vacuo, overnight. 7.9 g of dry solid material (light brown) (3) was obtained. The cationic saccharide (3) i.e. starch derivatized with betaine aldehyde, shown in scheme I is mono derivatized i.e. one primary hydroxyl group of the starch has reacted with betaine aldehyde.

### Example 12. Derivatizing β-Cyclodextrin with Betaine Aldehyde According to the Present Invention

The derivatization was performed similarly as in Example 10. A mixture containing 45.2% betaine aldehyde, 42.4% choline chloride and 12.4% betaine (3.6 mmole of betaine aldehyde present, pH 7.5) was used for the reaction with 0.586 g β-cyclodextrin (3.6 mmole AGU). Water was evaporated at 70° C. and 85 mbar, and 2.068 g of a yellow gel like material was obtained.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for producing cationic saccharide comprising
providing a mixture comprising betaine aldehyde and a saccharide;
allowing the betaine aldehyde to react with the saccharide; and obtaining cationic saccharide.

2. The method according to claim 1, wherein the betaine aldehyde is obtained from choline chloride by oxidation.

3. The method according to claim 1, wherein the mixture comprising the betaine aldehyde and the saccharide is obtained by oxidizing choline chloride for producing a solution comprising betaine aldehyde; and adding a saccharide to the solution comprising the betaine aldehyde for producing a mixture comprising betaine aldehyde and saccharide.

4. The method according to claim 3, wherein a catalyst is present in the oxidation.

5. The method according to claim 1, wherein the reaction takes place in a liquid medium or a mixture of liquid mediums.

6. The method according to claim 5, wherein the liquid medium is water, deep eutectic solvent (DES) system or a mixture thereof.

7. The method according to claim 6, wherein the eutectic solvent (DES) system comprises betaine based DES system, choline chloride based DES system or a mixture thereof.

8. The method according to claim 6, wherein the deep eutectic solvent (DES) system comprises betaine DES with 1,3-dimethylurea, betaine DES with 1,3-dimethylurea and water, betaine DES with N-methylurea, betaine DES with N-methylurea and water, betaine DES with glycerol, choline chloride DES with 1,3-dimethylurea, choline chloride DES with 1,3-dimethylurea and water, choline chloride DES with N-methylurea, choline chloride DES with N-methylurea and water, choline chloride DES with isosorbide, betaine hydrochloride with 1-methylurea, chlorocholine chloride with 1-methylurea or a mixture thereof.

9. The method according to claim 1, wherein the saccharide comprises monosaccharides, disaccharides, oligosaccharides, polysaccharides or a mixture thereof.

10. A cationic saccharide comprising a saccharide derivatized with betaine aldehyde.

11. The cationic saccharide according to claim 10, wherein the saccharide comprises, monosaccharides, disaccharides, oligosaccharides, polysaccharides or a mixture thereof.

12. The cationic saccharide according to claim 10, wherein the cationic saccharide is starch derivatized with betaine aldehyde or cyclodextrin derivatized with betaine aldehyde.

13. The cationic saccharide according to claim 10, wherein the cationic saccharide is produced with the method according to any one of claims 1-9.

14. A method for producing cationic saccharide, said method comprising utilizing betaine aldehyde.

15. A method for treating water, treating paper, or for anionic trash fixing, said method comprising utilizing the cationic saccharide produced with the method according to claim 1, as a water treatment agent.

16. The method of claim 15, wherein the cationic saccharide acts as a flocculant in water treatment, in paper treatment, as a retention agent, in anionic trash fixing as a fixative.

17. The method according to claim 2, wherein the mixture comprising the betaine aldehyde and the saccharide is obtained by oxidizing choline chloride for producing a solution comprising betaine aldehyde; and adding a saccharide to the solution comprising the betaine aldehyde for producing a mixture comprising betaine aldehyde and saccharide.

18. The method according to claim 17, wherein a catalyst is present in the oxidation.

19. The method according to claim 2, wherein the reaction takes place in a liquid medium or a mixture of liquid mediums.

20. The method according to claim 3, wherein the reaction takes place in a liquid medium or a mixture of liquid mediums.
